(19) United States
(12) Patent Application Publication
(10) Pub. No.: US 2016/0275548 A1
(43) Pub. Date: Sep. 22, 2016

(54) INTEGRATING ADVERTISEMENT IMPRESSIONS WITH USER IDENTITY FOR SEARCH ADVERTISEMENTS

(71) Applicant: Facebook, Inc., Menlo Park, CA (US)

(72) Inventors: Santhosh Raman, Redmond, WA (US); Ash Wahi, Seattle, WA (US)

(21) Appl. No.: 14/659,578

(22) Filed: Mar. 16, 2015

(51) Int. Cl. G06Q 30/02

(52) U.S. Cl. CPC G06Q 30/0246; G06Q 30/0277; G06Q 30/0256

(57) ABSTRACT

An advertiser can request that an advertising system track the advertiser's advertising campaign (“ad campaign”), which includes advertisements that share similar advertisement content, timeframe, or budget. The advertising system can track users' interactions with the advertisements of the ad campaign by incorporating click tags that redirect the user through the advertising system before directing them to the landing page of the advertisement. When a user is redirected through the advertising system by a click tag, the advertising system can log an impression in association with the advertisement contain the click tag. The impressions can then be associated with an identity of the user that is defined outside of the ad campaign and can thus be used to link impressions across different ad campaigns.

### BACKGROUND

This invention relates generally to advertising tracking, and specifically to associating user identity with search advertisements.

There are several types of advertisements that can be used to promote an action to a user. Search advertisements (“search ads”) are related to and displayed with results from search queries. Typically, the advertiser has designated certain search keywords such that, when a user conducts a search using one of those keywords, the advertiser's search ad may be displayed. Display advertisements (“display ads”), on the other hand, are presented to users separately on a web page in locations that may have been purchased by the advertiser, such as in banner advertisements displayed at the top of or across a web page, or in certain slots along a side or in various locations on the page. Advertisers generally use a combination of advertisement types to promote products to users and may use a number of different advertisement publishers to deliver their advertisements to users. For example, an advertiser may use one advertisement publisher for search ads, another advertisement publisher for display ads in one geographic region, and yet another advertisement publisher for display ads in another geographic region. Due to the number of different advertisement publishers and different advertisement channels (e.g., search channel and display channel), it can be difficult keep track of which user has seen which advertisements in the campaigns put on by the various advertisement publishers. Ad campaigns commonly are not integrated across multiple channels such that an advertiser can track how his ad campaign is performing as his ad is shown in different channels, such as both in the search and display channels. Lacking this information can lead to reduced efficiency in advertisement targeting, increased cost, and lost profits for the advertiser. In addition, search ad channels typically do not provide access to the identity of the user who performed the search and received the search ad impression, making it difficult to effectively track conversions and assign attribution across different impressions.

### SUMMARY

An advertising system allows a more integrated view of an advertiser's advertising campaigns (“ad campaigns”) across a variety of channels and links the advertisement impressions (“ad impressions”) to user identity. Advertisers can readily track ad impressions across search ad campaigns and integrate these with impressions that occur in other ad channels, such as display ad campaigns. This is beneficial because it allows the advertiser to determine how its ads are performing in both contexts, including the search ads where the advertiser may have purchased certain search keywords that can result in its ad being displayed with search results and, for example, the display ads where the advertiser may have purchased certain slots on a webpage such that its ad is displayed to a user when the user navigates to that page. Since the advertiser can track impressions across these various channels, including the search channel that historically has not been linked to user identity, the advertiser can better assign attribution for a conversion to the various different impressions across the different advertising channels.

An advertiser can request that an advertising system track the advertiser's ad campaign, which includes advertisements that share similar advertisement content, timeframe, or budget. The advertising system can track impressions or users' interactions with the advertisements of the ad campaign by incorporating click tags that redirect the user through the advertising system before directing them to the landing page of the advertisement. When a user is redirected through the advertising system by a click tag, the advertising system can log an impression in association with the advertisement containing the click tag. The impressions can then be associated with an identity of the user that is defined outside of the ad campaign and can thus be used to link impressions across different ad campaigns. Search ad campaigns that commonly have not included identity in the past can now be identity based, and can thus be integrated with display ad campaigns since the user's identity can be known in both channels. Additionally, when a conversion occurs for a user (e.g., a product that was advertised is ultimately purchased by the user), the conversion can be attributed to the different ad impressions for that user across the different ad channels, including the search channel.

### BRIEF DESCRIPTION OF THE DRAWINGS

FIG. 1 is a block diagram of a system environment in which an advertising system operates, in accordance with an embodiment of the invention.

FIG. 2 is a block diagram of an advertising system, in accordance with an embodiment of the invention.

FIG. 3 is an interaction diagram of an exemplary process for tracking search ad performance with an advertising system and a search partner, according to one embodiment.

FIG. 4 is an interaction diagram of an exemplary process for tracking search ad performance with an advertising system, according to one embodiment.

FIG. 5 is an interaction diagram illustrating a process for logging impressions and conversions of an advertisement by an advertising system 160, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Architecture

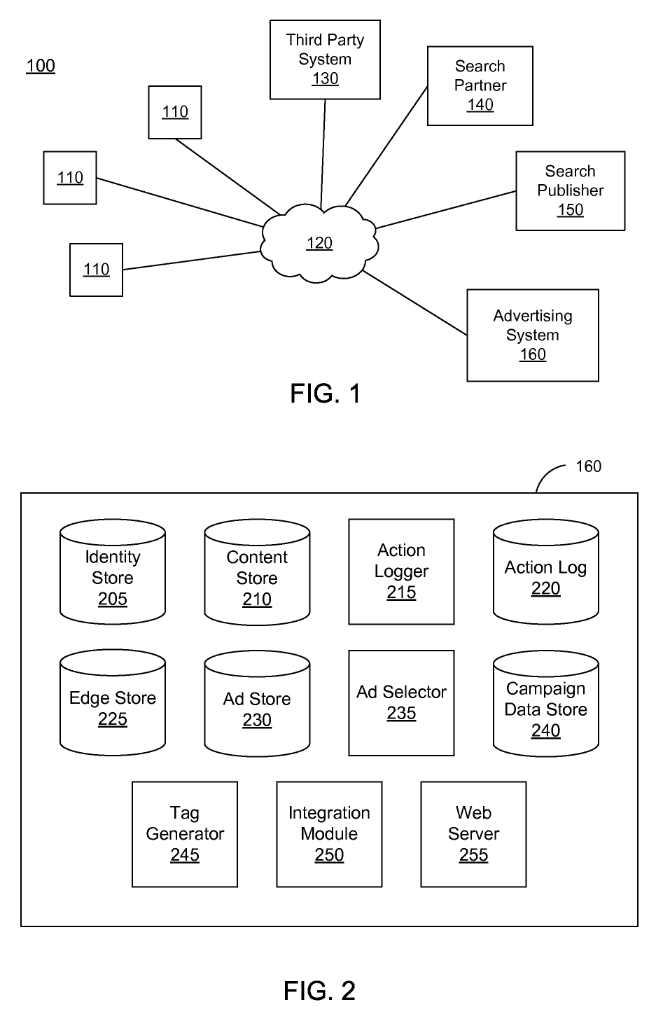

FIG. 1 is a high level block diagram of a system environment 100 for an advertising system 160. The system environment 100 shown by FIG. 1 comprises one or more client devices 110, a network 120, one or more third-party systems 130, a search partner 140, a search publisher 150, and the advertising system 160. In alternative configurations, different and/or additional components may be included in the system environment 100. The embodiments described herein can be adapted to online systems that are not advertising systems 160. For example, in some embodiments, the advertising system 160 is a social networking system.

The client devices 110 are one or more computing devices capable of receiving user input as well as transmitting and/or receiving data via the network 120. In one embodiment, a client device 110 is a conventional computer system, such as a desktop or laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the advertising system 160. For example, a client device 110 executes a browser application to enable interaction between the client device 110 and the advertising system 160 via the network 120. In another embodiment, a client device 110 interacts with the advertising system 160 through an application programming interface (API) running on a native operating system of the client device 110, such as IOS®or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the advertising system 160, which is further described below in conjunction with FIG. 2. In one embodiment, the third party system 130 is an advertiser that uses advertisements to engage with users. The third-party system 130 can engage with users through several different types of advertisements, like search ads and display ads. Search ads are advertisements that are chosen based on and displayed along with results from search queries, whereas display ads are shown to users in the form of banner advertisements, and the like.

In another embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party website 130 may also communicate information to the advertising system 160, such as advertisements, content, or information about an application provided by the third party website 130.

One or more search partners 140 may also be coupled to the network 120 for communicating with the advertising system 160. In one embodiment, the search partner 140 manages the delivery of a third party system 130′s search ads to users. For example, the search partner 140 may control what time of day the advertisements are served to users based on information about when the advertisement will perform the best. Additionally, the search partner 140 may optimize search ad delivery with respect to cost and performance. One example of a search partner is MARIN SOFTWARE®.

One or more search publishers 150 can also be coupled to the network 120. The search publisher 150 publishes results of search queries and selects search ads to display with the results. Examples of search publishers 150 include GOOGLE®, and BINGO®, or any other search system that allow a user to enter a search query and provides to the user ads along with the search results.

FIG. 2 is an example block diagram of an architecture of an advertising system 160. The advertising system 160 shown in FIG. 2 includes an identity store 205, a content store 210, an action logger 215, an action log 220, an edge store 225, an ad store 230, an ad selector 235, a campaign data store 240, a tag generator 245, an integration module 250, and a web server 255. In other embodiments, the advertising system 160 may include additional, fewer, or different components for various applications. In some embodiments, one or more of the modules of FIG. 2, and/or the functions described below for those modules, are instead included within the search partner 140 or the search publisher 150. Conventional components such as network interfaces, security functions, load balancers, failover servers, management and network operations consoles, and the like are not shown so as to not obscure the details of the system architecture.

Each user of the advertising system 160 is associated with an identity, which is stored in the identity store 205. The identity of a user can be designated by a unique identifier of the user. In some embodiments, a user's identity is stored in or linked to a user profile. A user profile includes declarative information about the user that was explicitly shared by the user and may also include profile information inferred by the advertising system 160. In one embodiment, a user profile includes multiple data fields, each describing one or more attributes of the corresponding user of the advertising system 160. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with identification information of users of the advertising system 160 displayed in an image. A user profile in the identity store 205 may also maintain references to actions by the corresponding user performed on content items in the content store 210 and stored in the action log 220. Where the advertising system 160 is or is associated with a social networking system, the user profiles can include various social networking data for a user, including a user's connections within the social networking system information about actions the user has taken in the system (e.g., liking or commenting on certain posts in the user's newsfeed on the social networking system, sharing certain posts, joining groups, attending events, etc.).

In some embodiments, the advertising system 160 has access to the actual user identity for users of the system. For example, in a social networking system, the system knows the identity of its users if the user is logged into the system, and thus can link actions taken as a user is navigating the Internet to the particular user and link the user to his social networking user profile. In other embodiments, the advertising system 160 may not have direct access to the user identity, but may acquire it by partnering or otherwise sharing information with a system that tracks identity, such as a social networking system. In one example, an advertising system 160 uses cookies to track its users (which do not typically provide the identity of the user but only provide an identity of the device being used by the user), and partners with a social networking system or other system having access to user identity tracked via a user identifier. The social networking system hashes or otherwise encrypts its user identifier and provides the hashed ID to the advertising system 160 or writes the hashed ID into a cookie used by the advertising system 160 such that the advertising system 160 can track user identity. In another example in which the advertising system 160 uses cookies to track its users, the advertising system 160 applies a method via which the cookie is correlated with a user identifier used by another system, such as a social networking system, such that the identity of the user can be determined. An example of this type of correlation is further explained in U.S. application Ser. No. 14/641,256, filed on Mar. 6, 2015, which is hereby incorporated by reference herein in its entirety. Thus, in some cases, the identity stored in the identity store is an identity obtained via this correlation.

The content store 210 stores objects that each represent various types of content. Examples of content represented by an object include a page post, a status update, a photograph, a video, a link, a shared content item, a gaming application achievement, a check-in event at a local business, a brand page, or any other type of content. Social networking system users may create objects stored by the content store 210, such as status updates, photos tagged by users to be associated with other objects in the social networking system, events, groups or applications. In some embodiments, objects are received from third-party applications separate from the advertising system 160. In one embodiment, objects in the content store 210 represent single pieces of content, or content “items.” Hence, users of the advertising system 160 are encouraged to communicate with each other by posting text and content items of various types of media through various communication channels. This increases the amount of interaction of users with each other and increases the frequency with which users interact within the advertising system 160.

The action logger 215 receives communications about user actions internal to and/or external to the advertising system 160, populating the action log 220 with information about user actions. Examples of actions include viewing an advertisement, interacting with an advertisement, adding a connection to another user, sending a message to another user, uploading an image, reading a message from another user, viewing content associated with another user, attending an event posted by another user, among others. In addition, a number of actions may involve an object and one or more particular users, so these actions are associated with those users as well and stored in the action log 220.

The action log 220 may be used by the advertising system 160 to track user actions on the advertising system 160, as well as actions on third party systems 130 that communicate information to the advertising system 160. Users may interact with various objects on the advertising system 160, and information describing these interactions are stored in the action log 210. Examples of interactions with objects include: interacting with an advertisement, commenting on posts, sharing links, and checking-in to physical locations via a mobile device, accessing content items, and any other interactions. Additional examples of interactions with objects on the advertising system 160 that are included in the action log 220 include: commenting on a photo album, communicating with a user, establishing a connection with an object, joining an event to a calendar, joining a group, creating an event, authorizing an application, using an application, expressing a preference for an object (“liking” the object) and engaging in a transaction. Additionally, the action log 220 may record a user's interactions with advertisements on the advertising system 160 as well as with other applications operating on the advertising system 160. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the advertising system 160. For example, an e-commerce website that primarily sells sporting equipment at bargain prices may recognize a user of an advertising system 160 through a social plug-in enabling the e-commerce website to identify the user of the advertising system 160. Because users of the advertising system 160 are uniquely identifiable, e-commerce websites, such as this sporting equipment retailer, may communicate information about a user's actions outside of the advertising system 160 to the advertising system 160 for association with the user. Hence, the action log 220 may record information about actions users perform on a third party system 130, including webpage viewing histories, advertisements that were engaged, purchases made, and other patterns from shopping and buying.

In one embodiment, an edge store 225 stores information describing connections between users and other objects on the advertising system 160 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the advertising system 160, such as expressing interest in a page on the social networking system, sharing a link with other users of the social networking system, and commenting on posts made by other users of the social networking system.

In one embodiment, an edge may include various features each representing characteristics of interactions between users, interactions between users and object, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the advertising system 160, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the advertising system 160 over time to approximate a user's affinity for an object, interest, and other users in the advertising system 160 based on the actions performed by the user. A user's affinity may be computed by the advertising system 160 over time to approximate a user's affinity for an object, interest, and other users in the advertising system 160 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and

U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the identity store 205, or the identity store 205 may access the edge store 225 to determine connections between users.

One or more advertisement requests (“ad requests”) are included in the ad store 230. An advertisement request includes advertisement content and a bid amount. The advertisement content is text, image, audio, video, or any other suitable data presented to a user. In various embodiments, the advertisement content also includes a landing page specifying a network address to which a user is directed when the advertisement is accessed. The advertisement content may also be part of an ad campaign, in which one or more pieces of advertisement content share a budget, timeframe, and/or performance objective. Examples of performance objectives include impressions and conversions. Impressions occur when a user is provided with an advertisement or when a user that is viewing an advertisement clicks on the advertisement. Conversions occur when the user viewing the advertisement completes the action that the advertisement is promoting. For example, if the advertisement is promoting sale of a pair of COLE HAAN® shoes, the user buying the pair of shoes would be a conversion.

The bid amount is associated with an advertisement by an advertiser and is used to determine an expected value, such as monetary compensation, provided by an advertiser to the advertising system 160 if the advertisement is presented to a user, if the advertisement receives a user interaction, or based on any other suitable condition. For example, the bid amount specifies a monetary amount that the advertising system 160 receives from the advertiser if the advertisement is displayed and the expected value is determined by multiplying the bid amount by a probability of the advertisement being accessed.

Additionally, an advertisement request may include one or more targeting criteria specified by the advertiser. Targeting criteria included in an advertisement request specify one or more characteristics of users eligible to be presented with content in the advertisement request. For example, targeting criteria are a filter to apply to fields of a user profile, edges, and/or actions associated with a user to identify users having user profile information, edges or actions satisfying at least one of the targeting criteria. Hence, the targeting criteria allow an advertiser to identify groups of users matching specific targeting criteria, simplifying subsequent distribution of content to groups of users.

In one embodiment, the targeting criteria may specify actions or types of connections between a user and another user or object of the advertising system 160. The targeting criteria may also specify interactions between a user and objects performed external to the advertising system 160, such as on a third party system 130. For example, the targeting criteria identifies users that have taken a particular action, such as sending a message to another user, using an application, joining a group, leaving a group, joining an event, generating an event description, purchasing or reviewing a product or service using an online marketplace, requesting information from a third-party system 130, or any other suitable action. Including actions in the targeting criteria allows advertisers to further refine users eligible to be presented with content from an advertisement request. As another example, targeting criteria may identify users having a connection to another user or object or having a particular type of connection to another user or object.

In some cases, the advertising system 160 may itself provide and possibly even serve ads to users, while in other cases the advertising system may work with a search partner 140 that provides the ads and a search publisher 150 that serves the ads. Where the advertising system 160 serves ads, when an opportunity to present an advertisement is received for a user, e.g., from an ad request, the ad selector 235 selects one or more advertisements from the ad store 230 for presentation to the user. In one embodiment, the ad selector 235 identifies targeting criteria associated with a user and retrieves ad requests having the targeting criteria. The ad selector 235 may retrieve additional user characteristics from the user profile store 305, the content store 310, the action log 320, and the edge store 325 and account for the additional user characteristics when evaluating ad requests. Based on characteristics of the user (“user characteristics”) the ad selector 235 determines a user's likelihood of interacting with the content of various ad requests. In one embodiment, the ad selector 235 uses an auction process to rank ad requests according to expected values to the advertising system 160 for presenting content from various ad requests, with an expected value of an ad request based on a bid amount associated with the ad request and a determined likelihood of the user interacting with content in the ad request. Based on the ranking from the auction process, the ad selector 235 selects one or more ad requests and communicates content of selected ad requests to a client device 110 or to a third party system 130 for presentation to the user. The web server 255 communicates content from the selected one or more ad requests to a client device 110 or a third-party system 130 for presentation. In the case of search ads, the ad selector 235 selects ads from the ad store 230 based on the search keywords entered by the user, and the auction process is used to rank ad requests in generally the same manner described above, ultimately resulting in the ad selector 235 selecting an ad for presentation to a user.

The campaign data store 240 stores information associated with advertisements in an ad campaign. Advertisements in an ad campaign may be linked by a number of characteristics, like budget, timeframe or performance objectives. These campaign characteristics can be stored in the campaign data store 240 in association with the specific ad campaign they describe. Additionally, information related to impressions and conversions of advertisements within the ad campaign, ad tracking parameters, and ad group dimensions can also be stored in the campaign data store 240. In some embodiments, tracking tags are also stored in association with ad campaigns in the campaign data store.

The advertising system 160 is able to track the impressions and conversions of advertisements through the uses of tags, which are created in the tag generator 245. Tags can be appended to a network address or URL to redirect a user through the advertising system 160 before taking them to the original network address or URL. Impressions can be tracked with click tags included in the advertisement. In some embodiments, the click tag or certain information associated with the click tag is appended to the network address that leads to the advertisement's landing page. Conversions can be tracked with action tags that are similarly appended to the network addresses associated with actions on the landing page. Such actions that might typically be tracked as a conversion can include purchasing a product that was advertised, visiting a particular advertised page, interacting with content on a page, joining ad advertised group, purchasing tickets to an advertised event, buying an advertised service, among many other possibilities.

A landing page for an advertisement is the page to which an advertisement leads when a user clicks on a link in the advertisement. A landing page may have multiple actions that can be taken and thus have multiple action tags. For example, an advertisement for a women's clothing store may feature a purple blouse and can have a landing page that is the product page of that purple blouse on the clothing store's website. From there, there are several ways in which the user can interact with the landing page. The user may choose to add the purple blouse to her shopping cart and subsequently purchase the purple blouse. Alternatively, the user might like one of the “recommended” items better, and thus click on a picture of that item, which leads the user to its product page. Alternatively yet, the user may not like the purple blouse or any of the recommended items and instead might browse categories of clothing, like “New Arrivals,” “Top Looks,” or “Petites,” and click on a corresponding link for those categories. Each of those are different actions that can be taken from the advertisement's landing page that the third party system 130 may want to track. Accordingly, each of those actions could have its own associated action tag.

The integration module 250 combines and analyzes the data stored in the campaign data store 240, the ad store 230, the action log 220 and the identity store 205. For example, the integration module 250 can associate an impression that is stored in the action log 220 with a user identity stored in the identity store 205 and advertisement content from an ad campaign stored in the campaign data store 240. The combination of this information then allows the advertising system 140 to be able to identify a user that has interacted with a particular advertisement from a particular ad campaign and some of the circumstances during which that happened (i.e., time of day, day of the week, placement on the viewing page). The integration module 250 can also integrate data between different ad campaigns and different types of ad campaigns by combining data from the different campaigns. For example, the integration module 250 can combine ad impressions and conversions from a search ad campaign and a display ad campaign such that the two campaigns use the same set of user identities. This allows the advertising system 160 to know which search ads and display ads a user has interacted with, despite them being part of different types of ad campaigns. Additionally, in some embodiments, the integration module 250 generates a report based on the data stored in the campaign data store. Using this information, the advertiser can gain various insights into his ad campaigns and how they are each performing (e.g., which of the search ad channel or display ad channel is more effective ad getting conversions), can apply attribution models across the channels to attribute credit for the conversion to different impressions across different campaigns, can track campaigns across different devices since the identity of the user is known, etc.

The web server 255 links the advertising system 160 via the network 120 to the one or more client devices 110, as well as to the one or more third party systems 130. The web server 160 serves web pages, as well as other web-related content, such as JAVA®, FLASH®, XML and so forth. The web server 255 may receive and route messages between the advertising system 160 and the client device 110, for example, instant messages, queued messages (e.g., email), text messages, short message service (SMS) messages, or messages sent using any other suitable messaging technique. A user may send a request to the web server 255 to upload information (e.g., images or videos) that are stored in the content store 210. Additionally, the web server 255 may provide application programming interface (API) functionality to send data directly to native client device operating systems.

### Search Ad Tracking

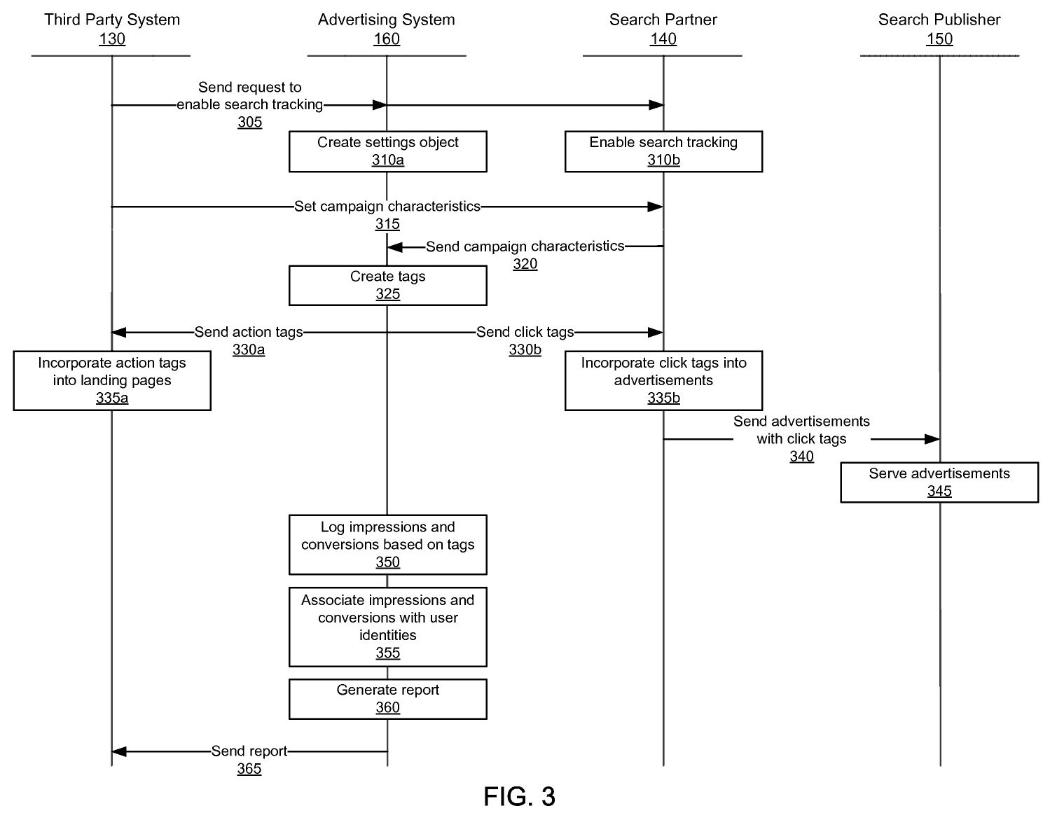

FIG. 3 is an interaction diagram of an exemplary process for tracking search ad performance with an advertising system 160 and a search partner 140, according to one embodiment. Search ads associated with a third party system 130 can be tracked and integrated with user identity based on information exchanged between the advertising system 160, the search partner 140 and a search publisher 150.

To initiate the search ad tracking process, the third party system 130 sends 305 a request to both the advertising system 160 and the search partner 140 to enable search tracking for one or more ad campaigns. The advertising system 160 then sets up the search tracking process by creating 310a a settings object for ad campaigns of the third party system 130. The settings object allows certain settings for the ad campaign to be designated by the third party system 130, such as what types of tracking to do for different campaigns, what analyses to perform on the data, etc. The search partner 140 also enables 310b search tracking in some way within its own system. The third party system 130 also sets 315 ad campaign characteristics within the search partner 140′s system, which are then sent 320 to the advertising system 160 by the search partner 140. The received campaign characteristics can be stored as part of the settings object for that ad campaign, for example.

The advertising system 160 is able to track a user's interactions with a particular search ad through the use of tags. Click tags track when a user has clicked on an advertisement, while action tags track when a user has clicked on a portion of the landing page of the advertisement. After the tags have been created 325, the action tags are sent 330a to the third party system 130 and the click tags are sent 330b to the search partner 140. The search partner 140 incorporates 335b the click tags into advertisements, and the third party system 130 then incorporates 335a the action tags into the landing pages of the advertisements.

The search partner 140 sends 340 the advertisements with their incorporated click tags to the search publisher 150, which serves 345 the advertisements to users. As the advertisements are served 345, the advertising system 160 logs 350 impressions and conversions based on the tags. The impressions and conversions are then associated 355 with user identities. In some embodiments, the user identities are also associated with impressions and conversions of display ads.

In some embodiments, the advertising system receives additional information from the search partner 140 and the search publisher 150. For example, the search partner 140 may provide ad group dimensions, such as the time distribution or geographic regions of the advertisements that were displayed. For example, the search publisher 150 may provide value-tracking parameters associated with each ad impression. Examples of value-tracking parameters include the geographic location of the device on which the click was made, the type of device on which the click was made, information about the keywords used for the search that resulted in the click, how well the search keyword matched the advertisement, or where the advertisement was placed. In some embodiments, this additional information is used to help associate 355 the impressions and conversions with user identities.

Finally, the advertising system 160 generates 360 a report that is sent 365 to or otherwise made available for viewing by the third party system 130. The report is generated 360 based on the impressions and conversions that have been associated 355 with user identities. Additionally, the report can be based on other information that is related to the ad campaign. For example, value-tracking parameters and costs can be received from the search publisher 150, and ad group dimensions can be received from the search partner 140.

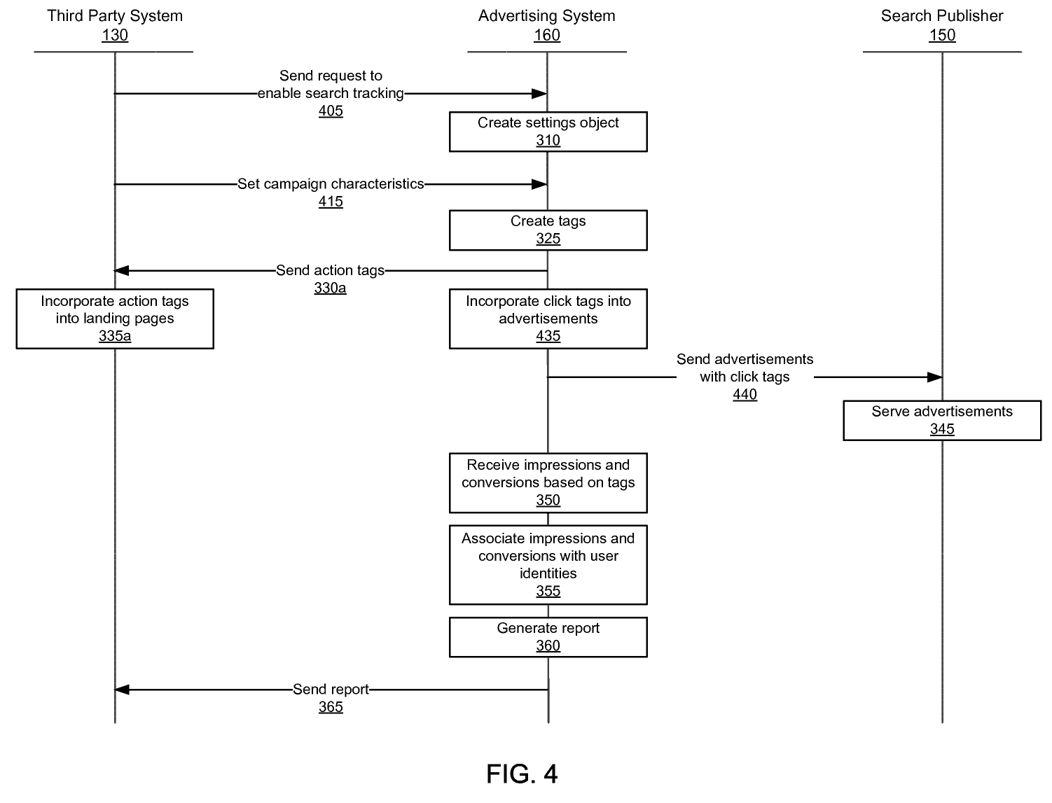

FIG. 4 is an interaction diagram of a process for tracking search ad performance with an advertising system 160, according to one embodiment. The process shown in FIG. 4 is similar to that of FIG. 3, but the process of FIG. 4 does not involve a search partner 150. Instead, the advertising system 160 takes on the functions previously performed by the search partner 140. Specifically, the third party system 130 only sends 305 a request to enable search tracking to the advertising system 160 and sets 415 the campaign characteristics directly with the advertising system 160. Additionally, because there is no search partner 140, the advertising system incorporates 435 the click tags into the advertisements and then sends 440 the advertisements with click tags to the search publisher 150. Steps 310, 325, 330a, 335a, 345, 350, 355, 360 and 365 are otherwise generally the same as in FIG. 3. In one embodiment, the advertising system 160 also determines ad group dimensions related to the ad campaign.

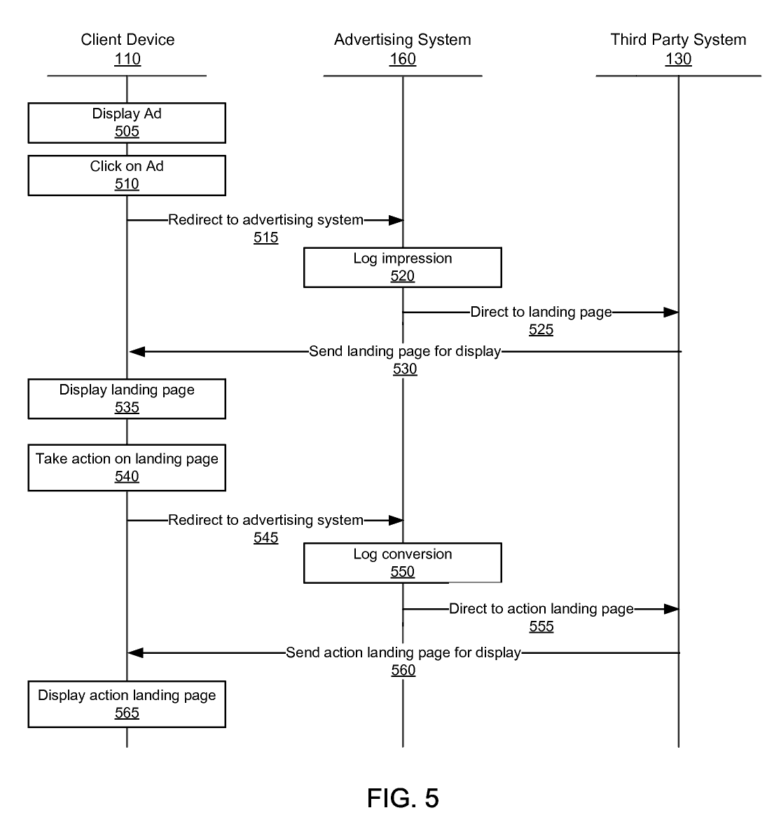

FIG. 5 is an interaction diagram illustrating a process for logging impressions and conversions of an advertisement by an advertising system 160, according to one embodiment.

An advertisement is displayed 505 on a client device 110. When a user of the client device 110 clicks 510 on the advertisement, the click tag in the advertisement causes the user to be redirected 515 to the advertising system 160. This allows the advertising system 160 to log 520 the impression before directing 525 the user to the landing page, which is sent 530 back to the client device 110 for display 535. If the user takes 540 an action on the landing page, the action tag associated with that action on the landing page redirects 545 the user to the advertising system 160 to log 550 a conversion. The user is then directed 555 to the action landing page, which is sent 560 back to the client device 110 and displayed 565.

### Conclusion

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving a request to track search ads for a search ad campaign of an advertiser;
providing a plurality of click tags for association with the search ads, each of the click tags being specific to a particular search ad and being capable of redirecting a user, who selects a link in the particular search ad, through the advertising system before directing the user to a landing page of the particular search ad;
for each of a plurality of users who is redirected to the advertising system by one of the plurality of click tags:
storing an ad impression for the search ad specified by the click tag, and determining an identity of the user based on a match to an identifier for the user;
integrating the stored ad impressions for the search ad campaign with ad impressions for display ads shown to a plurality of users in a display ad campaign of the advertiser, the ad impressions of users in the search ad campaign and the display ad campaign being linked based on the determined identity for each of the users; and
generating a report based on the integrated ad impressions.

2. The method of claim 1, wherein providing a plurality of click tags comprises:
generating the plurality of click tags;
incorporating each of the click tags into the particular search ad; and
sending the search ads to a search publisher that provides the search ads to the user.

3. The method of claim 1, wherein the plurality of click tags are provided to a search partner that incorporates the click tags into the search ads.

4. The method of claim 1, wherein the click tag is appended to a URL of the search ad.

5. The method of claim 1, further comprising:
providing a plurality of action tags for association with the landing pages of the search ads, each of the action tags being specific to a particular action that can be taken on the landing page and being capable of redirecting a user that initiates the particular action through the advertising system before completing the action;

6. The method of claim 5, further comprising for each of a plurality of users who is redirected to the advertising system by one of the plurality of action tags:
storing an ad conversion for the action and the search ad specified by the action tag; and
determining an identity of the user based on a match to an identifier for the user.

7. The method of claim 6, further comprising:
integrating the stored ad conversions for the search ad campaign with ad conversions for display ads shown to the plurality of users in the display ad campaign of the advertiser, the ad conversions of users in the search ad campaign and the display ad campaign being linked based on the determined identity for each of the users.

8. The method of claim 7, wherein the report is generated based on the integrated ad conversions.

9. A computer program product comprising a computer-readable storage medium containing computer program code for:
receiving a request to track search ads for a search ad campaign of an advertiser;
providing a plurality of click tags for association with the search ads, each of the click tags being specific to a particular search ad and being capable of redirecting a user, who selects a link in the particular search ad, through the advertising system before directing the user to a landing page of the particular search ad;
for each of a plurality of users who is redirected to the advertising system by one of the plurality of click tags:
storing an ad impression for the search ad specified by the click tag, and
determining an identity of the user based on a match to an identifier for the user;
integrating the stored ad impressions for the search ad campaign with ad impressions for display ads shown to a plurality of users in a display ad campaign of the advertiser, the ad impressions of users in the search ad campaign and the display ad campaign being linked based on the determined identity for each of the users; and
generating a report based on the integrated ad impressions.

10. The computer program product of claim 9, wherein providing a plurality of click tags comprises:
generating the plurality of click tags;
incorporating each of the click tags into the particular search ad; and
sending the search ads to a search publisher that provides the search ads to the user.

11. The computer program product of claim 9, wherein the plurality of click tags are provided to a search partner that incorporates the click tags into the search ads.

12. The computer program product of claim 9, wherein the click tag is appended to a URL of the search ad.

13. The computer program product of claim 9, further comprising computer program code for:
providing a plurality of action tags for association with the landing pages of the search ads, each of the action tags being specific to a particular action that can be taken on the landing page and being capable of redirecting a user that initiates the particular action through the advertising system before completing the action;

14. The computer program product of claim 13, further comprising computer program code, for each of a plurality of users who is redirected to the advertising system by one of the plurality of action tags, for:
storing an ad conversion for the action and the search ad specified by the action tag; and
determining an identity of the user based on a match to an identifier for the user.

15. The computer program product of claim 14, further comprising computer program code for:
integrating the stored ad conversions for the search ad campaign with ad conversions for display ads shown to the plurality of users in the display ad campaign of the advertiser, the ad conversions of users in the search ad campaign and the display ad campaign being linked based on the determined identity for each of the users.

16. The computer program product of claim 15, wherein the report is generated based on the integrated ad conversions.

17. A system comprising:
a processor; and
a non-transitory computer-readable memory comprising instructions that when executed by the processor cause the processor to:
receive a request to track search ads for a search ad campaign of an advertiser;
provide a plurality of click tags for association with the search ads, each of the click tags being specific to a particular search ad and being capable of redirecting a user, who selects a link in the particular search ad, through the advertising system before directing the user to a landing page of the particular search ad;
for each of a plurality of users who is redirected to the advertising system by one of the plurality of click tags:
store an ad impression for the search ad specified by the click tag, and
determine an identity of the user based on a match to an identifier for the user;
integrate the stored ad impressions for the search ad campaign with ad impressions for display ads shown to a plurality of users in a display ad campaign of the advertiser, the ad impressions of users in the search ad campaign and the display ad campaign being linked based on the determined identity for each of the users; and
generate a report based on the integrated ad impressions.

18. The system of claim 17, wherein the instructions to provide a plurality of click tags comprise:
generate the plurality of click tags;
incorporate each of the click tags into the particular search ad; and
send the search ads to a search publisher that provides the search ads to the user.

19. The system of claim 17, wherein the plurality of click tags are provided to a search partner that incorporates the click tags into the search ads.

20. The system of claim 17, wherein the click tag is appended to a URL of the search ad.

21. The system of claim 17, wherein the instructions further cause the processor to:
provide a plurality of action tags for association with the landing pages of the search ads, each of the action tags being specific to a particular action that can be taken on the landing page and being capable of redirecting a user that initiates the particular action through the advertising system before completing the action;

22. The system of claim 21, wherein the instructions further cause the processor, for each of a plurality of users who is redirected to the advertising system by one of the plurality of click tags, to:
store an ad conversion for the action and the search ad specified by the action tag; and
determine an identity of the user based on a match to an identifier for the user.

23. The system of claim 22, wherein the instructions further cause the processor to:
integrate the stored ad conversions for the search ad campaign with ad conversions for display ads shown to the plurality of users in the display ad campaign of the advertiser, the ad conversions of users in the search ad campaign and the display ad campaign being linked based on the determined identity for each of the users.

24. The system of claim 23, wherein the report is generated based on the integrated ad conversions.
